(19) United States
(12) Patent Application Publication
(10) Pub. No.: US 2026/0349182 A1
(43) Pub. Date: Nov. 5, 2026

(54) OPTICAL WAVEGUIDE AND EXTENDED REALITY DEVICE

(71) Applicant: Beijing Zitiao Network Technology Co., Ltd., Beijing (CN)

(72) Inventor: Wen XIONG, Beijing (CN)

(21) Appl. No.: 19/483,073

(22) PCT Filed: Jul. 30, 2024
(86) PCT No.: PCT/CN2024/108379

§ 371 Date: Nov. 10, 2025

(30) Foreign Application Priority Data
Aug. 1, 2023 (CN) 202310961873.8

(51) Int. Cl. G02B 6/34; G02B 27/01

(52) U.S. Cl. CPC G02B 6/34; G02B 27/0172

(57) ABSTRACT

An optical waveguide and an extended reality device are provided. The optical waveguide includes: a grating, a first substrate, and a second substrate, where the grating is arranged on at least one surface of the first substrate, the second substrate is arranged on at least one surface of the first substrate, and a refractive index of the second substrate is lower than that of the first substrate.

The present disclosure claims priority to Chinese Patent Application No. 2023109618738, filed on Aug. 1, 2023, and the disclosure of the above patent application is incorporated herein by reference in its entirety as part of the present disclosure.

### TECHNICAL FIELD

Embodiments of the present disclosure relate to an optical waveguide and an extended reality device.

### BACKGROUND

An optical waveguide is an important component in extended reality (XR) display, and is especially a core of an augmented reality (AR) display system. The working principle of the optical waveguide is to couple light emitted by an opto-mechanical system into a transparent parallel plate, transmit light in the parallel plate without loss through total internal reflection, and finally export the light at a human eye through a coupling-out grating, so that the light enters the human eye, thereby achieving the fusion of a displayed image and the real world.

### SUMMARY

Embodiments of the present disclosure provide an optical waveguide and an extended reality device.

In a first aspect, an embodiment of the present disclosure provides an optical waveguide, including: a grating, a first substrate, and a second substrate, where the grating is arranged on at least one surface of the first substrate, the second substrate is arranged on at least one surface of the first substrate, and a refractive index of the second substrate is lower than that of the first substrate.

In some embodiments, the grating is arranged on a first surface of the first substrate, and the second substrate is arranged on a second surface of the first substrate.

In some embodiments, the first surface of the first substrate is a surface close to a light source.

In some embodiments, the second surface of the first substrate is a surface close to a light source.

In some embodiments, the first substrate and the second substrate are connected to each other by van der Waals force.

In some embodiments, a thickness of the second substrate is smaller than or equal to a thickness of the first substrate.

In some embodiments, the second substrates are arranged on both surfaces of the first substrate.

In some embodiments, a total thickness of the second substrates on both surfaces of the first substrate is smaller than or equal to a thickness of the first substrate.

In some embodiments, the grating is arranged between the first substrate and the second substrate.

In a second aspect, an embodiment of the present disclosure provides an extended reality device, including the optical waveguide according to the first aspect.

### BRIEF DESCRIPTION OF DRAWINGS

The above and other features, advantages and aspects of various embodiments of the present disclosure will become more apparent with reference to the following detailed description taken in conjunction with the drawings. Throughout the drawings, the same or similar reference numbers refer to the same or similar elements. It should be understood that the drawings are schematic and that parts and elements are not necessarily drawn to scale.

FIG. 1 is a schematic structural diagram of an optical waveguide according to an embodiment of the present disclosure;

FIG. 2 is a schematic structural diagram of an existing optical waveguide;

FIG. 3 is a schematic structural diagram of another optical waveguide according to an embodiment of the present disclosure;

FIG. 4 is a schematic structural diagram of yet another optical waveguide according to an embodiment of the present disclosure;

FIG. 5 is a schematic structural diagram of still another optical waveguide according to an embodiment of the present disclosure; and

FIG. 6 is a schematic diagram of an extended reality device according to an embodiment of the present disclosure.

### DETAILED DESCRIPTION

The present disclosure is further described in detail below with reference to the drawings and embodiments. It should be understood that the specific embodiments described herein are only used to explain the related invention, and are not intended to limit the invention. In addition, it should be noted that for the convenience of description, the drawings only show parts related to the related invention.

It should be noted that the embodiments of the present disclosure and the features in the embodiments may be combined with each other without conflict. The present disclosure is described in detail below with reference to the drawings and in conjunction with the embodiments.

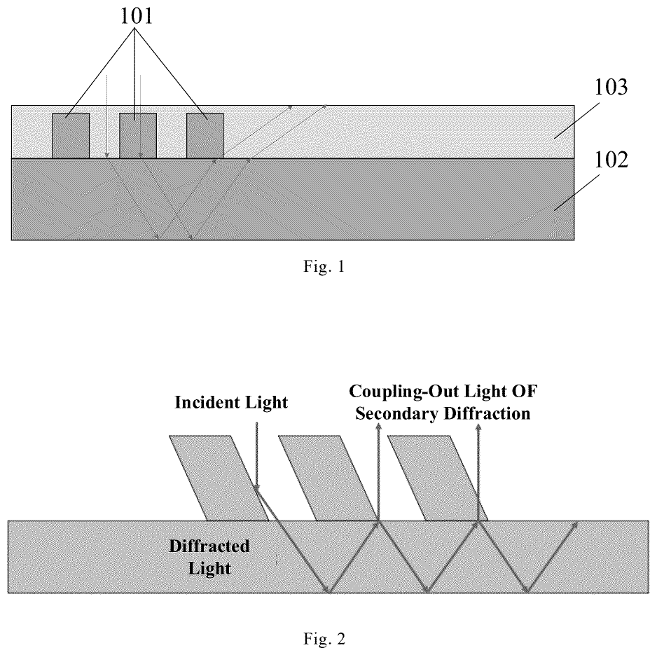

FIG. 1 is a schematic structural diagram of an optical waveguide according to an embodiment of the present disclosure. As shown in FIG. 1, the optical waveguide 100 may include a grating 101, a first substrate 102, and a second substrate 103. A refractive index of the second substrate 103 is usually lower than that of the first substrate 102, and higher than that of air. An optical waveguide is a medium device that guides the propagation of light waves therein.

The optical characteristics (such as the refractive index) of the grating periodically change in one or more directions, and this period is close to or even smaller than the wavelength of visible light, for example, this period is between 200-500 nm (nanometers). When the component of the propagation direction of the diffracted light in the direction perpendicular to the substrate is consistent with the original incident light, the grating is a transmission grating. When the component of the propagation direction of the diffracted light in the direction perpendicular to the substrate is opposite to the original incident light, the grating is a reflection grating.

The grating may be finely crafted, for example, it may be incised with thousands or even tens of thousands of grooves within a width of 1 cm. A grating that utilizes the diffraction of transmitted light is referred to as a transmission grating, while a grating that utilizes the diffraction of reflected light between two grooves is referred to as a reflection grating, for example, many parallel grooves may be incised on a surface coated with a metal layer and the smooth metal surface between the two grooves can reflect light.

As shown in FIG. 1, the grating 101 may be arranged on at least one surface of the first substrate 102. For example, the grating 101 may be a plurality of periodic structures incised on the first substrate 102, for example, a plurality of parallel grooves. However, the grating 101 is not limited to this, and the grating 101 may also be a plurality of periodic structures added on the first substrate 102, for example, a plurality of parallel protrusions.

As shown in FIG. 1, the second substrate 103 may be arranged on at least one surface of the first substrate 102. For example, the grating 101 and the second substrate 103 may be arranged on the same surface of the first substrate 102. For example, the second substrate 103 may be connected to the first substrate 102 by gluing. For example, an optical adhesive (Optically Clear Adhesive, OCA) may be used to bond the first substrate and the second substrate. OCA is a special adhesive for bonding transparent optical elements (such as lenses, etc.), and is required to be colorless and transparent, with a light transmittance of more than 95%, excellent bonding strength, curability at room temperature or medium temperature, and low curing shrinkage.

It should be noted that in FIG. 1, the grating and the second substrate are arranged on the same surface of the first substrate. FIG. 1 is only a schematic diagram of the optical waveguide. In a specific implementation, the positional relationships among the grating, the second substrate, and the first substrate may be defined according to actual conditions.

It should also be noted that the size of the grating in FIG. 1 is only illustrative, and the actual thickness of the grating is usually small.

The diffraction efficiency of a general optical waveguide is usually poor, which limits the brightness provided by an XR optical system. A very important reason for such poor diffraction efficiency of the optical waveguide is that the secondary diffraction of light and the coupling-in grating causes the coupling-out of the coupling-in light, resulting in brightness loss.

Reference now is made to FIG. 2, which is a schematic structural diagram of a general optical waveguide. In FIG. 2, when incident light encounters a grating, it undergoes diffraction and enters the optical waveguide substrate, where it reflects, the reflected light then encounters the grating again, undergoes diffraction once more, and couples out of the waveguide, so that it cannot continue to propagate into the human eye.

This phenomenon is more serious in the design of a monolithic full-color optical waveguide. Due to the different diffraction angles of red, green, and blue light, blue light propagates at a smaller total internal reflection angle, which is more prone to result in brightness loss due to secondary diffraction.

In order to solve this problem, two optical waveguides are generally used for full-color display, where one optical waveguide propagates red light and green light, and the other optical waveguide propagates green light and blue light. Through these two optical waveguides, the blue light also propagates at a larger angle, thereby avoiding losses caused by secondary diffraction. However, the design with two optical waveguides increases the weight, cost, and process complexity. Therefore, the monolithic full-color optical waveguide is still a more desirable solution.

In this solution, the grating is fabricated on a first substrate (a substrate with high refractive index), and a second substrate (a substrate with low refractive index) is arranged on the same surface or a different surface of the first substrate as the grating. Since the refractive index of the second substrate is higher than that of air and lower than that of the first substrate, the light is first diffracted by the grating, enters the substrate with high refractive index where it's reflected, and enters the substrate with low refractive index. Since the propagation angle of the light in the substrate with low refractive index increases, even if the substrate with low refractive index has smaller thickness, the propagation distance of the light in the plane can still be effectively increased, thereby avoiding secondary diffraction as much as possible.

On the other hand, since the material of the substrate with low refractive index is generally of low density, this layer of substrate will not add too much weight. Moreover, the substrate with low refractive index is not fabricated with a grating structure, and only a gluing step needs to be added in the process, therefore the processing complexity is reduced.

In some optional implementations, the grating 101 may be arranged on a first surface of the first substrate 102, and the second substrate 103 may be arranged on a second surface of the first substrate 102, that is, the grating 101 and the second substrate 103 are located on both sides of the first substrate 102, respectively.

In some optional implementations, the first surface of the first substrate 102 may be a surface close to a light source, that is, the grating 101 is arranged on the surface close to the light source, and the second substrate 103 is arranged on a surface away from the light source.

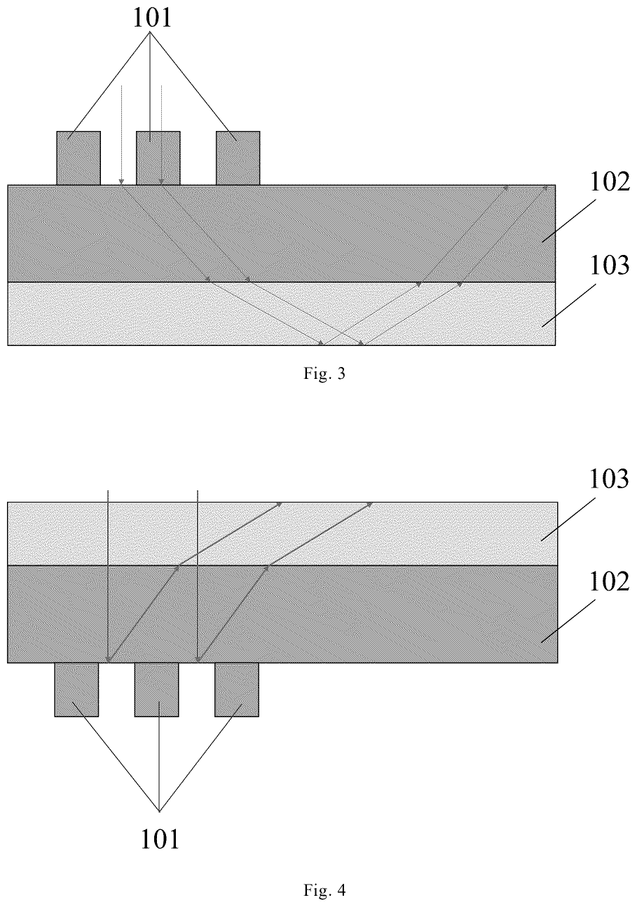

Reference now is made to FIG. 3, which is a schematic structural diagram of another optical waveguide according to an embodiment of the present disclosure. In FIG. 3, the grating 101 is arranged on the surface of the first substrate 102 close to the light source, and the second substrate 103 is arranged on the surface of the first substrate 102 away from the light source. In such case, the optical waveguide is a transmission optical waveguide.

Since the refractive index of the second substrate 103 is higher than that of air and lower than that of the first substrate 102, the light is first diffracted by the grating 101 and enters the first substrate 102.

However, due to the existence of the second substrate 103, the total internal reflection condition is destroyed on the surface where the first substrate 102 contacts the second substrate 103, and the light enters the second substrate 103. Due to the refraction effect, the propagation angle of the light in the second substrate 103 increases, so that even if the second substrate 103 has extremely smaller thickness, the propagation distance in the plane can still be effectively increased, thereby avoiding secondary diffraction as much as possible.

In some optional implementations, the second surface of the first substrate 102 may be a surface close to a light source, that is, the second substrate 103 is arranged on the surface close to the light source, and the grating 101 is arranged on the surface away from the light source.

With continued reference to FIG. 4, which is a schematic structural diagram of yet another optical waveguide according to an embodiment of the present disclosure. In FIG. 4, the grating 101 is arranged on the surface of the first substrate 102 away from the light source, and the second substrate 103 is arranged on the surface of the first substrate 102 close to the light source. In such case, the optical waveguide is a reflection optical waveguide.

Light enters the second substrate 103 and the first substrate 102 in sequence, undergoes total reflection in the first substrate 102, and enters the second substrate 103 because the total internal reflection condition is destroyed on the surface where the first substrate 102 contacts the second substrate 103. Due to the refraction effect, the propagation angle of the light in the second substrate 103 increases, so that even if the second substrate 103 has extremely smaller thickness, the propagation distance in the plane can still be effectively increased, thereby avoiding secondary diffraction as much as possible.

In some optional implementations, the first substrate 102 and the second substrate 103 may be connected to each other by van der Waals force. Van der Waals force may also be referred to as intermolecular force or Van der Waals force. The intermolecular force has three origins: the interaction between the permanent dipole moments of polar molecules; a polar molecule polarizes another molecule, generating induced dipole moments that attract each other; and the movement of electrons in a molecule generates an instantaneous dipole moment, which polarizes neighboring molecules instantaneously, the latter in turn enhances the original molecule's instantaneous dipole moment, and this mutual coupling produces electrostatic attraction These three forces contribute differently, and usually the third one makes the largest contribution. Here, the two substrates are connected to each other by van der Waals force, which further reduces the processing complexity of the optical waveguide.

In some optional implementations, the thickness of the second substrate 103 is usually smaller than or equal to the thickness of the first substrate 102. Since the propagation angle of the light in the substrate with low refractive index increases, even if the substrate with low refractive index has extremely smaller thickness, the propagation distance of the light in the plane can still be effectively increased. By confining the thickness of the substrate with low refractive index, the weight of the optical waveguide can be reduced as much as possible.

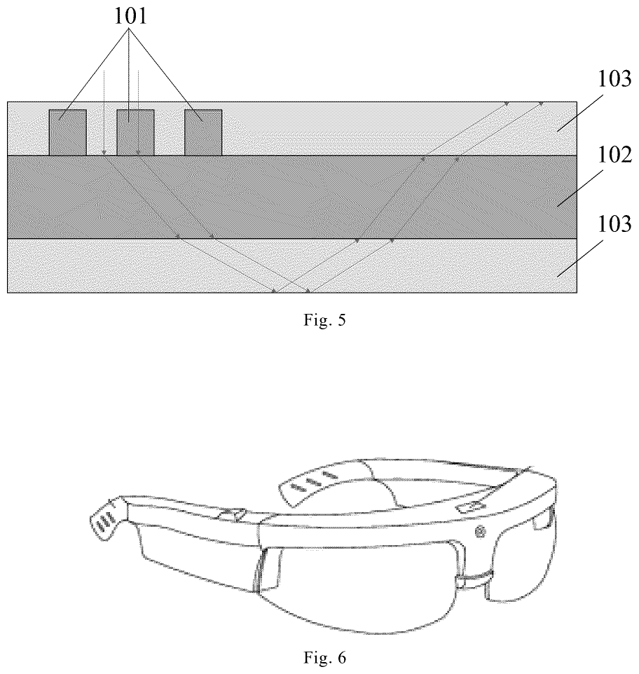

In some optional implementations, the second substrate 103 may be arranged on both surfaces of the first substrate 102. As shown in FIG. 5, FIG. 5 is a schematic structural diagram of still another optical waveguide according to an embodiment of the present disclosure. In FIG. 5, the light is first diffracted by the grating 101 and enters the first substrate 102. However, due to the existence of the second substrate 103, the total internal reflection condition is destroyed on the surface where the first substrate 102 contacts the second substrate 103, and the light enters the second substrate 103. Due to the refraction effect, the propagation angle of the light in the second substrate 103 increases. After total internal reflection in the second substrate 103, the light enters the first substrate 102 and then re-enters the second substrate 103, and the propagation angle of the light in the second substrate 103 increases again, thereby further avoiding secondary diffraction.

It should be noted that the optical waveguide in FIG. 5 is only illustrative, and the position of the grating may be set according to actual conditions. For example, the grating may be arranged between the first substrate and the second substrate, on the surface of the first substrate away from the light source; or the grating may be arranged on both surfaces of the first substrate.

In some optional implementations, the total thickness of the second substrates 103 on both surfaces of the first substrate 102 is usually smaller than or equal to the thickness of the first substrate 102. Since the propagation angle of the light in the substrate with low refractive index increases, even if the substrate with low refractive index has extremely smaller thickness, the propagation distance of the light in the plane can still be effectively increased. By confining the total thickness of the two substrates with low refractive indices, the weight of the optical waveguide can be reduced as much as possible.

In some optional implementations, the grating 101 may be arranged between the first substrate 102 and the second substrate 103. If the second substrates are arranged on both surfaces of the first substrate, the grating may be arranged between the first substrate and each second substrate.

The optical waveguide provided by the embodiment of the present disclosure includes the grating, the first substrate, and the second substrate. The grating is arranged on at least one surface of the first substrate, the second substrate is arranged on at least one surface of the first substrate, and the refractive index of the second substrate is lower than that of the first substrate, thereby avoiding secondary diffraction of light in the optical waveguide and reducing the brightness loss of the optical waveguide. In addition, since the material of the substrate with low refractive index usually has smaller density, this layer of substrate will not add too much weight. Moreover, the substrate with low refractive index is not fabricated with a grating structure, and only a gluing step needs to be added in the process, therefore the processing complexity is reduced.

FIG. 6 is a schematic diagram of an extended reality device according to an embodiment of the present disclosure. As shown in FIG. 6, the extended reality device may include the optical waveguide according to the embodiment of the present disclosure. The optical waveguide according to the embodiment of the present disclosure includes the first substrate and the second substrate with the refractive index lower than that of the first substrate. Since the propagation angle of the light in the substrate with low refractive index increases, the propagation distance of the light in the plane is effectively increased, and the secondary diffraction of the light in the optical waveguide is avoided. When the user uses the extended reality device including the optical waveguide, more light enters the human eye, and the brightness loss is reduced. In addition, since the material of the substrate with low refractive index usually has smaller density, this layer of substrate will not add too much weight. Moreover, the substrate with low refractive index is not fabricated with a grating structure, and only a gluing step needs to be added in the process, therefore the processing complexity is reduced.

The above description is only preferred embodiments of the present disclosure and an explanation of the applied technical principles. Those skilled in the art should understand that the scope of the present disclosure involved in the embodiments of the present disclosure is not limited to the technical solutions formed by the specific combination of the above technical features, and should also cover other technical solutions formed by any combination of the above technical features or equivalent features thereof without departing from the above inventive concept. For example, a technical solution formed by replacing the above features with (but not limited to) technical features with similar functions disclosed in the embodiments of the present disclosure.

1. An optical waveguide, comprising: a grating, a first substrate, and a second substrate, wherein
the grating is arranged on at least one surface of the first substrate, the second substrate is arranged on at least one surface of the first substrate; and
a refractive index of the second substrate is lower than a refractive index of the first substrate.

2. The optical waveguide according to claim 1, wherein the grating is arranged on a first surface of the first substrate, and the second substrate is arranged on a second surface of the first substrate.

3. The optical waveguide according to claim 2, wherein the first surface of the first substrate is a surface close to a light source.

4. The optical waveguide according to claim 2, wherein the second surface of the first substrate is a surface close to a light source.

5. The optical waveguide according to claim 2, wherein the first substrate and the second substrate are connected to each other by van der Waals force.

6. The optical waveguide according to claim 2, wherein a thickness of the second substrate is smaller than or equal to a thickness of the first substrate.

7. The optical waveguide according to claim 1, wherein the second substrates are arranged on both surfaces of the first substrate.

8. The optical waveguide according to claim 7, wherein a total thickness of the second substrates arranged on both surfaces of the first substrate is smaller than or equal to a thickness of the first substrate.

9. The optical waveguide according to claim 1, wherein the grating is arranged between the first substrate and the second substrate.

10. An extended reality device, comprising an optical waveguide, wherein the optical waveguide comprises: a grating, a first substrate, and a second substrate, wherein
the grating is arranged on at least one surface of the first substrate, the second substrate is arranged on at least one surface of the first substrate; and
a refractive index of the second substrate is lower than a refractive index of the first substrate.

11. The extended reality device according to claim 10, wherein in the optical waveguide, the grating is arranged on a first surface of the first substrate, and the second substrate is arranged on a second surface of the first substrate.

12. The extended reality device according to claim 11, wherein in the optical waveguide, the first surface of the first substrate is a surface close to a light source.

13. The extended reality device according to claim 11, wherein in the optical waveguide, the second surface of the first substrate is a surface close to a light source.

14. The extended reality device according to claim 11, wherein in the optical waveguide, the first substrate and the second substrate are connected to each other by van der Waals force.

15. The extended reality device according to claim 11, wherein in the optical waveguide, a thickness of the second substrate is smaller than or equal to a thickness of the first substrate.

16. The extended reality device according to claim 10, wherein in the optical waveguide, the second substrates are arranged on both surfaces of the first substrate.

17. The extended reality device according to claim 16, wherein in the optical waveguide, a total thickness of the second substrates arranged on both surfaces of the first substrate is smaller than or equal to a thickness of the first substrate.

18. The extended reality device according to claim 10, wherein in the optical waveguide, the grating is arranged between the first substrate and the second substrate.
